(19) United States
(12) Patent Application Publication
(10) Pub. No.: US 2009/0299848 A1
(43) Pub. Date: Dec. 3, 2009

(54) Method and Apparatus for a Promotional Couponing System

(75) Inventors: Ben Cao, Glendale, CA (US); John Hilbert, Torrance, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/088,083

(22) PCT Filed: Oct. 2, 2006
(86) PCT No.: PCT/US06/38492

§ 371 Date: Apr. 6, 2009

(30) Foreign Application Priority Data
Sep. 30, 2005 (US) 60722557

(51) Int. Cl. G06Q 30/00; G06Q 50/00; G06F 15/16

(52) U.S. Cl. 705/14.38; 705/14.1; 709/204

(57) ABSTRACT

A method and apparatus for the creation and management of promotional coupons are provided. Promotional coupon templates are written in a template definition language and promotions, promotional campaigns, and triggers for the generation and issuance of promotional coupons based on the promotional coupon templates are defined. The promotional coupons may be printed either in real time, based on a predetermined date and/or time, or based on other triggers by a printer. Furthermore, the method and apparatus facilitate management of the redemption of promotional coupons for use in a gaming, vending, or other business environment. The system uses a host system and a graphical front-end. The system further includes at least one printer and may include routing devices. The system may interface with other systems such as a point of sale system or slot accounting system.

### CROSS-REFERENCE TO RELATED APPLICATIONS

The present application claims the benefit U.S. Provisional Application No. 60/722,557, the contents of which are incorporated by reference as if stated in full herein.

### BACKGROUND OF THE INVENTION

1. Field of the Invention

This invention relates to a promotional couponing system for the creation and management of promotional coupon templates written in a template definition language, promotions, promotional campaigns, triggers, and the redemption of promotional coupons using a host system and a graphical front-end for the generation and issuance of promotional coupons either in real time, based on a predetermined date and/or time, or based on other triggers by a printer and the management of the redemption of promotional coupons for use in a gaming, vending, or other business environment.

2. Background

Gaming machine manufacturers have introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill acceptor that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

Cashless enabled gaming machines have found increasing acceptance and use in the gaming industry with players who enjoy the speed of play and ease of transporting their winnings around a gaming establishment and the gaming establishments who have realized significant labor savings in the form of reduced coin hopper reloads in the games, and an increase in revenue because of the speed of play.

Gaming establishments use multiple promotion methods to induce individuals to patronize the gaming establishment or associated gaming establishments. However, there is no method or system in place to create, issue, and manage promotional coupons, promotions, and promotional campaigns which may be transmitted to, stored in, and used by a printer already installed within a cashless enabled gaming machine system.

In addition, vending machine manufacturers have increasingly added additional printing features to their vending machines. One of these features is the ability to create promotional coupons from the vending machines. However, there is no method or system in place to create, issue, and manage promotional coupons, promotions, or promotional campaigns which may be transmitted to, stored in, and used by a printer.

There are a number of existing methods or system currently in place which accomplish some type of promotional coupon issuance or generation. In one existing method for promotional coupons is a system which edits the layout of a coupon template. While this method allows a user to design coupons, it does not allow the association of coupons to one or more promotions or the association of one or more promotions to a promotional campaign. Another problem with this method is the inability to copy coupon print regions from one coupon template to another template.

In another existing method for promotional coupons is the direct mailing of coupons from a gaming or other business establishment to consumers. One problem that plagues this existing method is that the promotion must be planned well in advance to accommodate the printing and mailing of the promotional coupons to consumers. Another problem is direct mailing and printing is not cost effective. Another problem is that the preprinted promotional coupons cannot be directly inserted into or read by a bill acceptor in a gaming or vending machine. The preprinted promotional coupons must be processed by hand, the process which lends itself to fraud and security issues such as forgery.

Another existing method for promotional coupons provides consumers the means to download promotions from a networked environment (typically the Internet) for a gaming or other business establishment. In addition to some of the problems cited for the previously described existing methods, problems for this existing method also include the lack of the consumer's presence at a gaming or other business establishment which reduces the promotion's overall effectiveness and coupon redemption.

In another related existing method is the issuance of comps by a gaming establishment to a consumer. Comps typically include free meals, drinks, show tickets, special room rates, room upgrades, match play coupons, and free cash. One problem with this existing method is that the comp is usually processed or issued by a cashier, pit boss, or floor person whereby it must be determined if the consumer should receive a comp.

Therefore, a need exists for a promotional coupon management system that allows an establishment to design coupons and promotional programs such that the coupons may be issued in a variety of different gaming and retail points of contact with customers. Systems in accordance with various aspects of the present invention meet such a need.

### DEFINITIONS

For the purposes of this application the following definitions apply:

“Gaming Establishment”—a gaming entity such as a casino.

“Business Establishment”—a business entity which may use a kiosk for consumer purchases such as movie tickets, parking tickets, venue tickets, etc., or a retail business entity.

“Host System”—a server or multiple servers, a computer connected to a network, a stand alone computer, a handheld device, or a wireless device used for application and data storage, data processing, and file transfers.

“CRC”—a commonly used mathematical formula used as a signature for the binary image of the firmware or data included in the sectional memory of a printer. Acronym for Cyclic Redundancy Check.

“Printer”—a printing device coupled to a cashless enabled game, a vending machine or kiosk, or a point-of-sale system.

“Print Region”—a print object as text, barcode, line, box, or graphic, used on a template which describes where to put the print object on a coupon or voucher, how to print the print object, the orientation of print (0, 90, etc.), and other special control factors.

“Template”—a collection of Print Regions referenced by a single identification byte that is used to format the positioning of Print Regions on a coupon or voucher.

“Printer Controller Unit”—a device internal or external to a printer which controls print jobs and receives and/or transmits data, among other functions.

“PTS”—acronym for Player Tracking System.

“POS”—acronym for Point Of Sale system.

### SUMMARY OF THE INVENTION

The present invention described herein provides solutions to the problems of these and other existing methods. For example, a restaurant opens down the street from a movie theatre. The movie theatre, equipped with a kiosk or multiple kiosks, each coupled to a printer, can issue movie tickets directly to a consumer. The restaurant wants to promote their business by offering customers of the movie theatre a buy-one-get-one-free dinner. The restaurant pays the movie theatre to advertise this promotion using promotional coupons generated from each printer in each kiosk at the movie theatre. The movie theatre or the restaurant creates the promotion and the promotional coupon for the restaurant using the present invention described herein. In addition, parameters and triggers for the promotion such as start and end date and time are set. The data for the promotion and promotional coupon may be saved on a host system. This data may be then transmitted to a printer in each kiosk at the movie theatre. Based on the criteria set up for the promotion, a consumer can receive the promotional coupon for the restaurant when the consumer purchases a movie ticket from a kiosk at the movie theatre.

In another example, a gaming establishment desires to create a promotion for a new cashless enabled slot machine by offering match play coupons. Using the present invention described herein, a gaming establishment creates a promotional coupon for the match play promotion. Parameters and triggers for the promotion such as start and end date and time, and number of coupons to issue are set. The data for the match play promotion and promotional coupon may be saved on a host system and sent to a printer in one or more cashless enabled gaming machines. After a consumer plays and cashes out of a cashless enabled gaming machine, and if the criteria set for the promotion is met, the consumer receives the match play promotional coupon. The consumer can then play the new cashless enabled slot machine using the match play promotional coupon by inserting the match play promotional coupon into the bill acceptor of the new cashless enabled slot machine.

In another solution to existing methods, the present invention can create promotional coupons, promotions, and promotional campaigns in real time, thereby allowing up-to-the-minute or last-minute implementations. For example, a gaming establishment desires to create a last-minute promotion to issue a promotional coupon to consumers who have played for more than two consecutive hours on the same gaming machine. Using the present invention described herein, the gaming establishment creates the promotional coupon template and the promotion. The data for the promotional coupon and promotion may be saved on the host system and sent to a printer in one or more cashless enabled gaming machines. If the criteria set for the promotion is met, the printer then issues the promotional coupon to a consumer who plays for more than two consecutive hours on the same gaming machine.

The present invention is a promotional couponing system which defines coupon templates written in a template definition language, promotions, and promotional campaigns for the creation and management of promotional coupons, promotions, promotional campaigns, and triggers using a host system and a graphical front-end to a template definition language for the generation and issuance of promotional coupons in real time, based on a predetermined date and/or time, or based on other triggers by a printer for use in a gaming, vending, or other business environment. In addition, the present invention may include a promotional couponing system which manages the redemption of promotional coupons.

In one aspect of the invention, promotional coupons include coupons for merchandise, food, beverages, parking, lodging, special events such as a boxing or a tournament, personal events such as a birthday or an anniversary, entertainment, and a free play of a game or certain types of games. These promotional coupons can offer a discount, a refund, a rebate, or a free product or service. Promotional coupon templates used to generate promotional coupons may be associated with one or a plurality of promotions based on triggers such as an issue period.

In another aspect of the invention, promotions include those for a tangible or intangible product, a service, an event, and lodging. Promotions may be associated with one or a plurality of promotional campaigns.

In another aspect of the invention, promotional campaigns include those for events such as a holiday, contest, drawing, tournament, and other special events such as boxing.

In another aspect of the invention, data for promotional coupons, promotions, and promotional campaigns may be transmitted to, stored in, and used by a printer, host system, and/or a routing device. The data may be stored partially resident in the printer and partially supplied by the host system or routing device.

In another aspect of the invention, when a gaming or other business establishment desires to define a promotional coupon, the business establishment uses a promotional coupon template editor to layout and print regions of text, graphics, barcodes, lines, and boxes are defined displays. A gaming or other business establishment defines the layout of a promotional coupon by placing print regions on the promotional coupon template. For example, if the user desires to place a barcode as a print region on the promotional coupon template, the user selects the barcode option to define the parameters for that barcode. The parameters include region ID, region data, region size, object ID, object rotation, object width, object justification, object attributes, print attributes, and print color among others. These parameters are also used to modify a print region.

In another aspect of the invention, the user can move any region to another area on a promotional coupon template, place a region in front of other regions, or place a region behind other regions.

In another aspect of the invention, a user may create multiple promotional coupon templates based on existing promotional coupon templates. In this embodiment, a gaming or other business establishment selects an existing promotional coupon template on which additional promotional coupon templates are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions on a promotional coupon template.

In another aspect of the invention, a user is allowed to adjust the workspace for structuring the promotional coupon template. Thus, if desired, the user can zoom in on the overall layout and print regions of a promotional coupon template to closely view and modify the overall layout and print regions. This feature also permits users to zoom out to view the overall layout and print regions of a promotional coupon template.

In another aspect of the invention, after the gaming or other business establishment defines the print regions for the promotional coupon template, the data for the promotional coupon template is stored in a document. The document contains multiple lines. A line in the document may consist of a unique identifies for the promotional coupon template, a comment, or a command and the associated parameters required to use that promotional coupon template, among others. The document is transmitted to, stored on a host system and may be incorporated into a new or existing promotion. The data may also be transmitted to, stored in, and used by a printer either alone or with other promotional coupon templates to generate a promotional coupon or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

In another aspect of the invention, a CRC is calculated based on the contents of the promotional coupon data. In this embodiment of the present invention, when a gaming or other business establishment desires to create or edit a promotional coupon template, the promotional coupon template editor displays. After a gaming or other business establishment creates or edits a promotional coupon template, the present invention inserts a tag or field into the promotional coupon template data file which identifies the promotional coupon template. The present invention then performs a boundary check on the data file and calculates the CRC based on the contents of the promotional coupon data file. After successful verification of the CRC, the present invention loads the data for each promotional coupon and sends the CRC to a printer or plurality of printers.

Furthermore, the present invention allows the overall layout and print regions of a promotional coupon template to be edited or deleted. The parameters for a print region which can be edited include region ID, region data, region size, object ID, object rotation, object width, object justification, object attributes, print attributes, and print color, among others.

When a gaming or other business establishment desires to use a promotional coupon in a promotion, the promotional couponing system defines promotions and promotional campaigns as displays. A gaming or other business establishment defines one or a plurality of triggers by which a promotional coupon or promotional coupons may be generated by a printer and issued to a user or player. These event-based triggers involve factors or parameters known to the printer directly or supplied by the host system These triggers can operate independently or in logical combination. These triggers are used to associate a promotional coupon or a plurality of promotional coupons with a promotion or plurality of promotions. In addition, these triggers may be used when a promotion is associated with a promotional campaign or a plurality of promotional campaigns. These triggers include amount wagered, amount lost, rate of play, length of play, issuance per trigger, birthday, frequency selector, and issue period, among others.

Other parameters used to define a promotion include promotion start and end dates, a promotion ending period based on number of issued coupons, promotion start and end times, issuing a name for the promotion, assigning one or a plurality of triggers to the promotion, and selecting one or a plurality of promotional coupons for use with the promotion.

The data for a promotion is transmitted to and stored on the host system and may be used in one or a plurality of promotional campaigns. Promotion data may include a unique identifier for each promotion. The data also may include the unique identifier of each associated promotional coupon to interlock data in each promotion with data in each associated promotional coupon. Data created for a promotion or a plurality of promotions may be transmitted to, stored in, and used by a printer to generate one or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

Furthermore, the present invention calculates the CRC based on the contents of the promotion data. In this embodiment of the present invention, when a gaming or other business establishment desires to create or edit a promotion, the promotional couponing, the promotions and promotional campaigns are defined displays. After a gaming or other business establishment creates or edits a promotion, the present invention inserts a tag or field into the promotion data file which identifies the promotion. The present invention then performs a boundary check on the data file and calculates the CRC based on the contents of the promotion file. After successful verification of the CRC, the present invention loads the data for each promotion and sends the CRC to a printer or plurality of printers.

Furthermore, the present invention allows promotions to be edited or deleted. The parameters for a promotion which can be edited include all those previously described.

When a gaming or other business establishment desires to define a promotional campaign, the promotional couponing system, the promotions and promotional campaigns are defined as displays. A gaming or other business establishment defines a promotional campaign by associating one or a plurality of predefined promotions to the promotional campaign, assigning a name to the promotional campaign, and selecting a promotional coupon and triggers.

The data for a promotional campaign is transmitted to and stored on the host system. Data for a promotional campaign may include a unique identifier for each promotional campaign. The data also may include the unique identifier for each associated promotion, each associated promotional coupon, or a combination thereof. Data created for a promotional campaign may be transmitted to, stored in, and used by a printer to generate one or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

Furthermore, the present invention allows promotional campaigns to be edited or deleted. The parameters for a promotional campaign which can be edited include the promotional campaign name, promotion associations, and type of promotional campaign, among others.

In addition, the present invention allows the export of promotional coupon templates and data for promotional coupons, promotions, and promotional campaigns for incorporation and use by external software applications such as a casino management system or player tracking system.

Furthermore, the present invention provides various methods of establishing communications with a printer for data transmission. In one aspect of the present invention, when a gaming or other business establishment desires to set up the communication port to which data is transmitted to a printer, the communication port settings displays. A gaming or other business establishment selects the communication port and the communication protocol baud rate, identifies the polling option and command, and initializes the communication port. In addition, a gaming or other business establishment can locate additional communication ports to which to establish communications.

In another aspect of the present invention, when a gaming or other business establishment desires to set up the respective communication ports to which gaming or vending vouchers and promotional coupon data is transmitted to a printer, the communication ports settings displays. A gaming or other business establishment selects a gaming or vending voucher file, selects the communication port and the communication protocol baud rate, and initializes the communication port for the gaming or vending voucher. A gaming or other business establishment repeats this process for a promotional coupon.

In another aspect of the invention, a gaming or other business establishment can also set the delay between print option which sets the delay print time between printing a gaming or vending voucher and printing a promotional coupon. A gaming or other business establishment can also disconnect the communication port for the gaming or vending voucher, the promotional coupon, or both.

In another aspect of the invention, when a gaming or other business establishment desires to view the parameters of a print job prior to sending a data to a printer, the print job controls display. A gaming or other business establishment can select options such as manually sending the print job, sending all print jobs without delay, sending all print jobs with delay, canceling a print job, and clearing the output log that is created when a print job is sent to a printer.

In another aspect of the invention, a gaming or other business establishment can also view the status of a printer. When desiring to do so, the printer status displays. A gaming or other business establishment can view any Universal Asynchronous Receiver Transmitter (UART) errors, view the printer library, and reset the printer if necessary.

In another aspect of the present invention, data for a promotional campaign which may be transmitted to a printer from a host system or routing device, stored in, and used by a printer to generate a promotional coupon or a plurality of promotional coupons, may be combined with data for a promotional coupon or plurality of promotional coupons. In this embodiment of the present invention, when a gaming or other business establishment desires to create or edit a promotional campaign, the promotional couponing system defines displays for the promotions and promotional campaigns. After a gaming or other business establishment creates or edits a promotional campaign, the present invention inserts a tag or field in the promotional campaign data file which identifies the promotional campaign. The present invention also calculates the CRC based on the contents of the promotional campaign data and sends the CRC to a printer or plurality of printers.

In another aspect of the present invention, a boundary check on the combined promotional coupon template or plurality of promotional coupon templates, print regions, graphics and other data which may be included with the promotion or promotional campaign data may be performed to ensure conformance with the resources and load requirements of the printer. In this embodiment of the present invention, after a gaming or other business establishment transmits data to a printer, the promotional couponing system performs the boundary check by determining the number of promotional coupon templates, print regions, graphics and other data which may be included with promotion or promotional campaign data. The promotional couponing system then verifies the CRC. After successful verification of the CRC, the promotional couponing system loads the data for each promotional coupon template and sends the CRC to a printer or plurality of printers.

In another aspect of the present invention, data for promotional coupon templates, promotions, and promotional campaigns is stored in the memory of the printer. In this embodiment of the present invention, the promotional couponing system transmits the data for promotional coupon templates, promotions, and promotional campaigns to a printer or plurality of such. When all parameters or triggers of a promotion or a promotional campaign are met, the printer uses the data stored in memory to generate a promotional coupon or a plurality of promotional coupons.

In another aspect of the present invention, data for promotional coupon templates, promotions, and promotional campaigns is stored in a routing device or a plurality of routing devices, each coupled to a host system and a printer or a plurality of printers. In this embodiment of the present invention, the promotional couponing system transmits the data for promotional coupon templates, promotions, and promotional campaigns to each routing device. When all the parameters or triggers for a promotion or promotional campaign are met, the routing device transmits the stored data to the printer or a plurality of printers to generate a promotional coupon or a plurality of promotional coupons.

In another aspect of the invention, the promotional couponing system monitors and tracks the redemption of promotional coupons. When a promotional coupon is redeemed at a point-of-sale location such as a store or restaurant, data gathered from the promotional coupon is transmitted to the promotional couponing system. For example, this data may come from barcode data, the unique identifier for each promotional coupon, or a combination thereof, among others.

In another aspect of the invention, to allow redemption of the promotional coupon, the data may be verified against data originally used to create a promotional coupon template, promotion, promotional campaign, a plurality of any, or a combination of any. If the data from the promotional coupon meets any condition or parameter originally set, the promotional coupon is redeemed.

In another aspect of the invention, the promotional couponing system is coupled to a point-of-sale server to validate the redemption of promotional coupons. Data gathered from a promotional coupon being redeemed is validated against data originally set for a promotional coupon, a promotion, a promotional campaign, a plurality of any, or a combination of any. If the data from the promotional coupon meets any condition or parameter originally set, the promotional coupon is redeemed.

In another aspect of the invention, the promotional couponing system is coupled to a gateway server in a gaming environment or a plurality of such, each gateway server coupled to a cluster controller which controls a plurality of slot machines. In this aspect, data from the promotional couponing system may be transmitted to a selected gateway server or plurality of such to permit the issuance of promotional coupons from each printer coupled to the selected slot machines.

In another aspect of the invention, the promotional couponing system is coupled to a player tracking server in a gaming environment to validate the redemption of promotional coupons. Player tracking data used with promotional coupon, promotion, or promotional campaign data is validated against data originally used for a promotional coupon, a promotion, a promotional campaign, a plurality of any, or a combination of any. If the data is verified, the promotional coupon is redeemed.

In another aspect of the invention, the promotional couponing system is coupled to a slot accounting server in a gaming environment to request data for the issuance of a promotional coupon or plurality of such based on a promotional coupon template. For example, using the invention described herein, a gaming establishment creates a promotional campaign which uses a trigger that issues a promotional coupon after a player plays 15 times on the same slot machine. The trigger uses data from the slot accounting server. Once the conditions and parameters of the trigger are met, a promotional coupon is issued. In another example, a trigger for amount wagered may be used to request amount wagered data from the slot accounting server. Once such data is received from the slot accounting server, a promotional coupon is issued.

In another aspect of the invention, the promotional couponing system is coupled to a slot accounting server in a gaming environment to verify the issuance of a promotion coupon or plurality of such based on a promotional coupon template. For example, data originally set in a promotional coupon template may include a machine identification. When a promotional coupon is issued, the identification of the issuing machine is transmitted from the slot accounting server and placed on a promotional coupon. When a promotional coupon is redeemed, the promotional couponing system verifies the data from the promotional coupon with the data originally set with a promotional coupon template. If the data matches, the promotional coupon is redeemed.

### BRIEF DESCRIPTION OF THE DRAWINGS

These and other features, aspects, and advantages of the present invention will become better understood with regard to the following description and accompanying drawings where:

FIG. 1 is an illustration of the main aspects of a promotional couponing system in accordance with an exemplary embodiment of the present invention.

FIG. 2 is a diagram illustrating the components of the promotional couponing system in accordance with an exemplary embodiment of the present invention.

FIG. 3 is a process flow diagram of the promotional couponing system in accordance with an exemplary embodiment of the present invention.

FIG. 4 is a process flow diagram of the promotional couponing system including routing devices in accordance with an exemplary embodiment of the present invention.

FIG. 5 is an illustration of the attributes of the print regions of a promotional coupon template in accordance with an exemplary embodiment of the present invention.

FIG. 6 is an illustration of triggers in accordance with an exemplary embodiment of the present invention.

FIG. 7 is an illustration of the attributes of the communication settings with a printer in accordance with an exemplary embodiment of the present invention.

FIG. 8 is an illustration of the attributes of the printer settings in accordance with an exemplary embodiment of the present invention.

FIG. 9 is an illustration of the data transmitted to and stored in the memory of a printer for promotional coupons, promotions, and promotional campaigns in accordance with an exemplary embodiment of the present invention.

FIG. 10 is a flow chart of a load, check, and verify CRC process for a promotional campaign in accordance with an exemplary embodiment of the present invention.

FIG. 11 is a process flow diagram for gaming vouchers and promotional data in a gaming environment in accordance with an exemplary embodiment of the present invention.

FIG. 12 is an illustration of the servers, cluster controllers, slot machines, and components thereof used for a promotional couponing system in a gaming environment in accordance with an exemplary embodiment of the present invention.

FIG. 13 is a process flow diagram for a promotional couponing system in a gaming environment for the management, issuance, and redemption of promotional coupons as related to point-of-sale purchases in accordance with an exemplary embodiment of the present invention.

FIG. 14 is an illustration of a promotional coupon including logical fields in accordance with an exemplary embodiment of the present invention.

### DETAILED DESCRIPTION

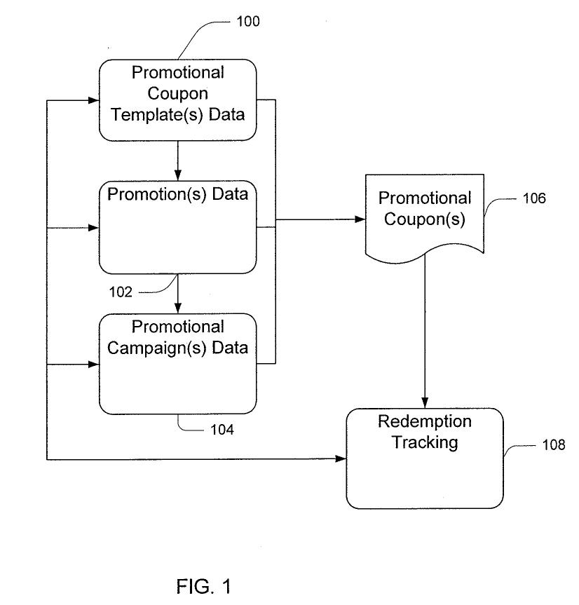

FIG. 1 is an illustration of the main aspects of a promotional couponing system in accordance with an exemplary embodiment of the present invention.

As illustrated, a promotional couponing system may use data 100 from a promotional coupon template or plurality of such, a promotion 102 or plurality of promotions, a promotional campaign 104 or a plurality of promotional campaigns, for the generation of a promotional coupon 106 or plurality of such, after which redemption of the promotional coupon is tracked (108).

Promotional coupons include coupons for merchandise, food, beverages, parking, lodging, special events such as a boxing or a tournament, personal events such as a birthday or an anniversary, entertainment, and a free play of a game or certain types of games. These promotional coupons can offer a discount, a refund, a rebate, or a free product or service. Promotional coupon templates used to generate promotional coupons may be associated with one or a plurality of promotions based on triggers such as an issue period.

Promotions include those for a tangible or intangible product, a service, an event, and lodging. Promotions may be associated with one or a plurality of promotional campaigns. In addition, promotional campaigns include those for events such as a holiday, contest, drawing, tournament, and other special events such as boxing.

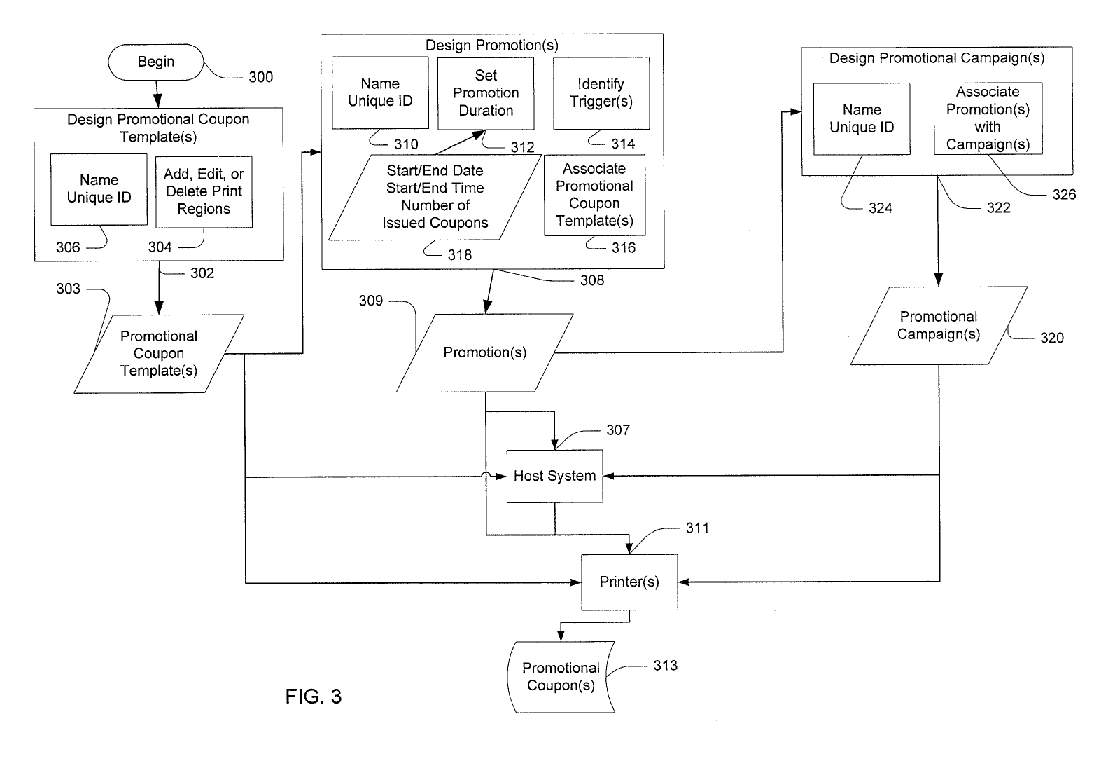

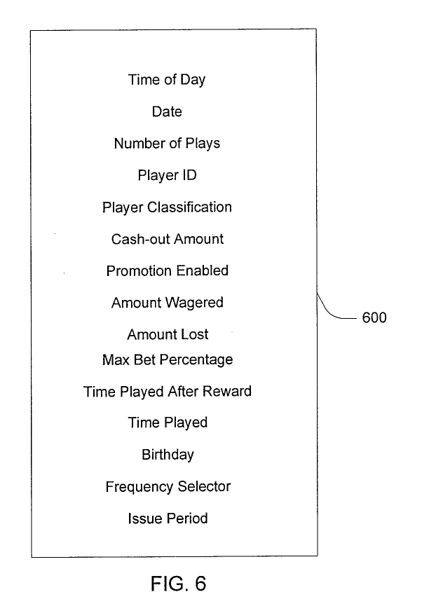

A promotional coupon template or plurality of such also may be associated with one or a plurality of promotions based on triggers described in FIG. 3 and FIG. 6.

Promotions may be associated with a promotional campaign or plurality of such.

After a promotional coupon is issued, redemption tracking of such may be based on promotional coupon template data, promotion data, or promotional campaign data.

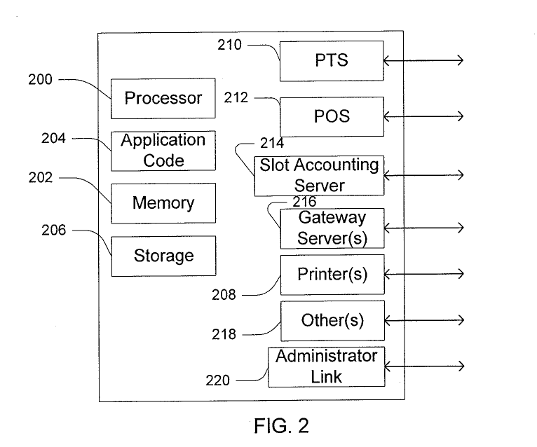

FIG. 2 is a diagram illustrating the components of the promotional couponing system in accordance with an exemplary embodiment of the present invention. A component or plurality of components shown in FIG. 2 could be optional.

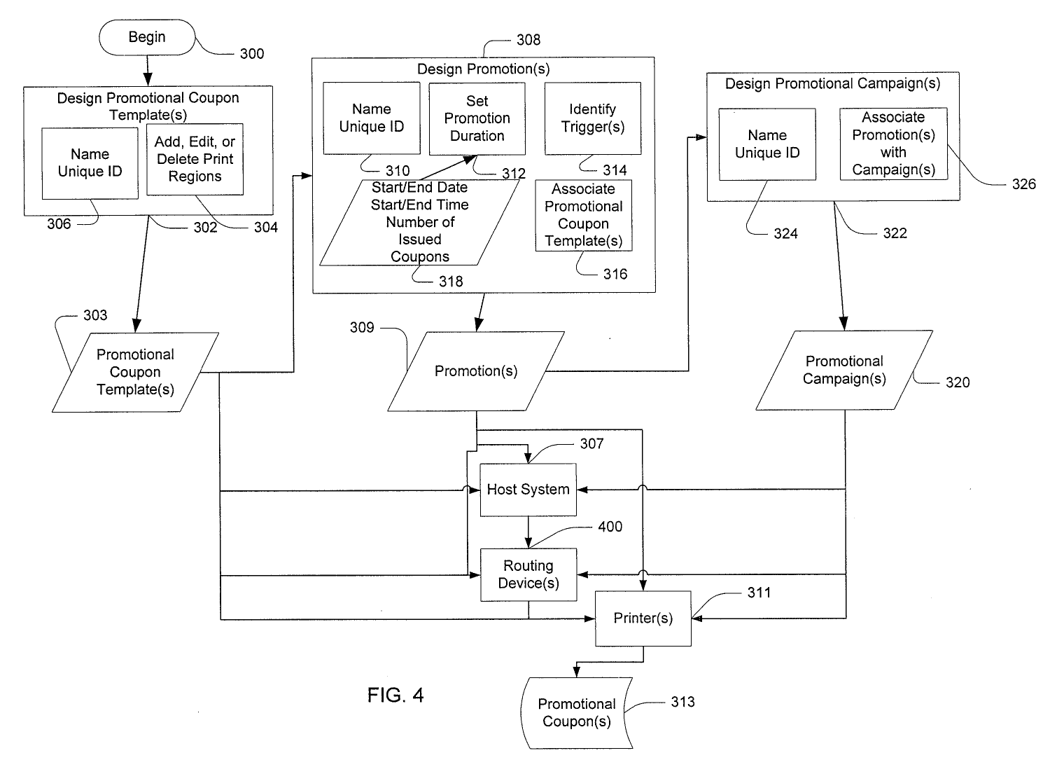

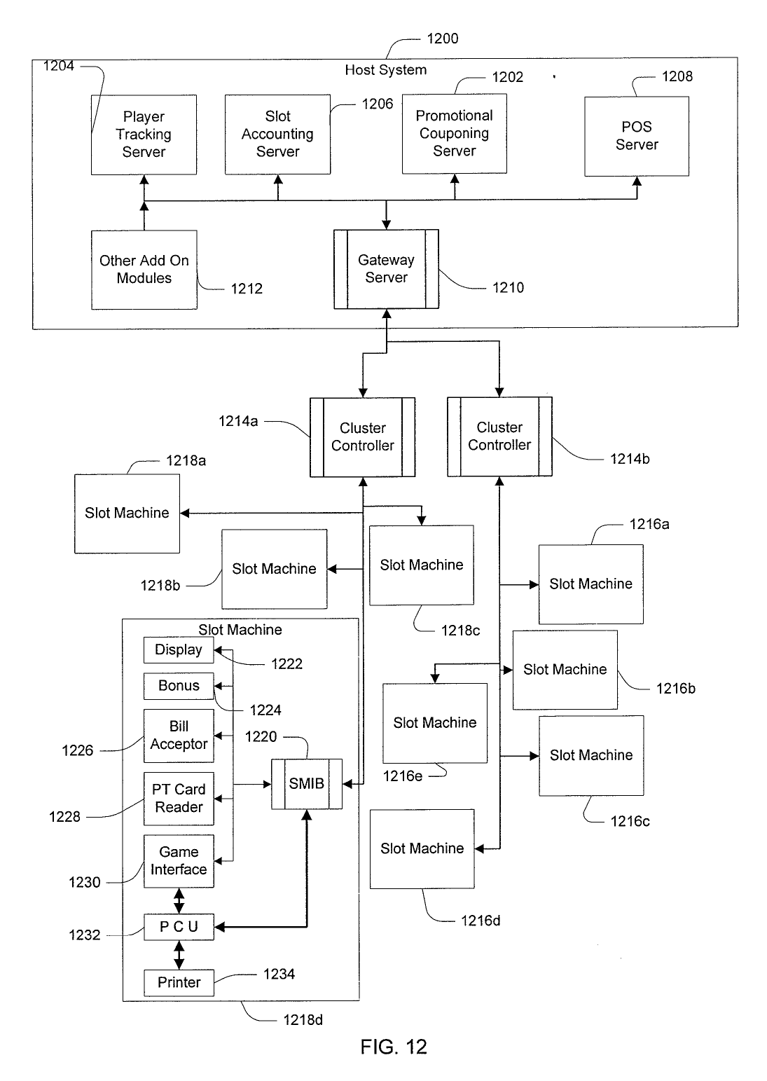

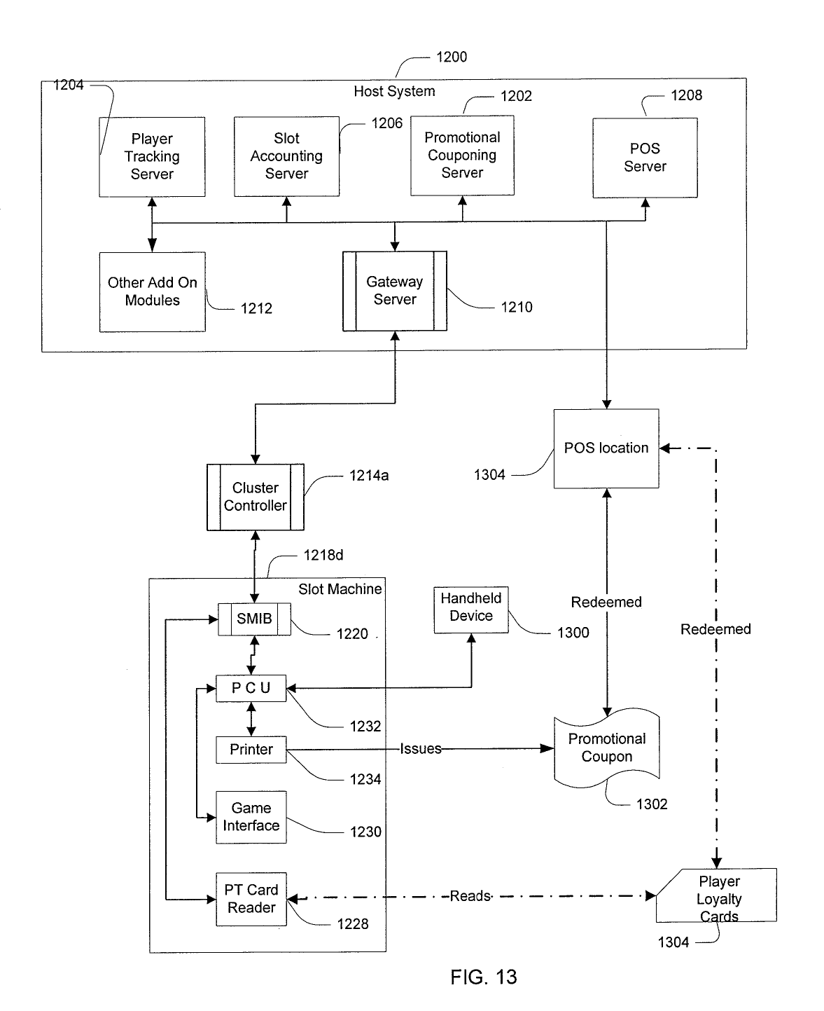

As shown in FIG. 2, the promotional couponing system comprises a processor 200, memory 202, application code 204 containing code for implementing the processes described herein, storage 206, and a plurality of interfaces to external devices and systems including an interface 208 to a plurality of printers. An exemplary device for the promotional couponing system would be a traditional network server. In FIG. 2, the processor, executing the application code, performs the following tasks:
(a) create and maintain a database for storing promotional coupon template, promotion, promotional campaign, triggers, and redemption data, then recalling any of that data at a later time to create a promotional coupon or plurality of such through one of its connected printers, either directly or through a coupled component such as a gateway.
(b) process data related to the creation of promotional coupon templates, promotions, and promotional campaigns, the data including triggers.
(c) process data related to the issuance of promotional coupons, the data including triggers.
(d) process data related to the redemption of promotional coupons.
(e) record and log its activities for statistical and monitoring purposes.
(f) transfer statistical data and activity logs and records to the promotional couponing system administrator.
(g) accept programming through its interface to a promotional couponing system administrator as to the algorithms, metrics, and triggers utilized for the creation of a promotional coupon template or plurality of such.
(h) set the communication options for both vouchers and promotional coupons to print using the same printer, including initializing each port and polling each printer.
(i) calculate the CRC based on promotional coupon or promotion data; thereafter, based on successful verification of the CRC, loading the promotional coupon or promotion data and sending the CRC to a printer or plurality of printers, either directly or through a coupled component such as a gateway.
(j) request data exchange through the promotional couponing system's interface to the PTS to determine if a promotional coupon or plurality of such is triggered as a result of a player being a member of a frequent player or membership club of a gaming establishment.
(k) request data exchange through the promotional couponing system's interface to the PTS to query player tracking data for the customization of a promotional coupon or plurality of such.
(l) request data exchange through the promotional couponing system's interface to the PTS to determine the validity of the redemption of a promotional coupon or plurality of such, thereby enabling player tracking data is validated against data originally used for a promotional coupon, a promotion, a promotional campaign, a plurality of any, or a combination of any.
(m) request data exchange through the promotional couponing system's interface to the POS for the issuance of a promotional coupon or plurality of such, whereby a trigger or plurality of triggers using data from the POS is used.
(n) request data exchange though the promotional couponing system's interface to the POS to monitor and track the redemption of a promotional coupon or plurality of such, whereby point-of-sale data may be verified against data originally used to create a promotional coupon template, promotion, promotional campaign, a plurality of any, or a combination of any.
(o) request data exchange through the promotional couponing system's interface to the Slot Accounting Server for the issuance of a promotional coupon or plurality of such, whereby a trigger or plurality of triggers using data from the Slot Accounting Server is used.
(p) request data exchange through the promotional couponing system's interface to the Slot Accounting Server to monitor and track the redemption of a promotional coupon or plurality of such, whereby data such as issuing machine may be verified against data originally used to create a promotional coupon template, promotion, promotional campaign, a plurality of any, or a combination of any.
(q) request data exchange through the promotional couponing system's interface to a Gateway Server or plurality of such for the issuance of a promotional coupon or plurality of such, whereby data and one or a plurality of triggers is transmitted to each Gateway Server to permit the issuance of promotional coupons from each printer coupled to selected slot machines.
(r) request data exchange through the promotional couponing system's interface to a Gateway Server or plurality of such to monitor and track the redemption of a promotional coupon or plurality of such, whereby data from the Gateway Server or its coupled devices as later described in FIG. 12 and FIG. 13 may be verified against data originally used to create a promotional coupon template, promotion, promotional campaign, a plurality of any, or a combination of any.
(s) request data exchange through the promotional couponing system's interface to Other(s), which may be any other system, network, or device such as a routing device as later described in FIG. 4 for the issuance of a promotional coupon or plurality of such, whereby data and one or a plurality of triggers is transmitted to and stored in such.
(t) request the promotional couponing system's interface to the network of printers in the system to create a promotional coupon or plurality of such.
The interfaces comprising the protocols, messaging logic, hardware, and buffering necessary to exchange data with the promotional couponing system's processor and application, and the:
(a) PTS 210
(b) POS 212
(c) Slot Accounting Server 214
(d) Gateway Server(s) 216
(e) Printer(s) 208
(f) Other(s) 218
(g) Administrator Link 220
   A number of the interfaces for the system may exist on the same physical hardware connection, the attached devices being individually or group-addressable nodes on that connection.

FIG. 3 is a process flow diagram of the promotional couponing system in accordance with an exemplary embodiment of the present invention.

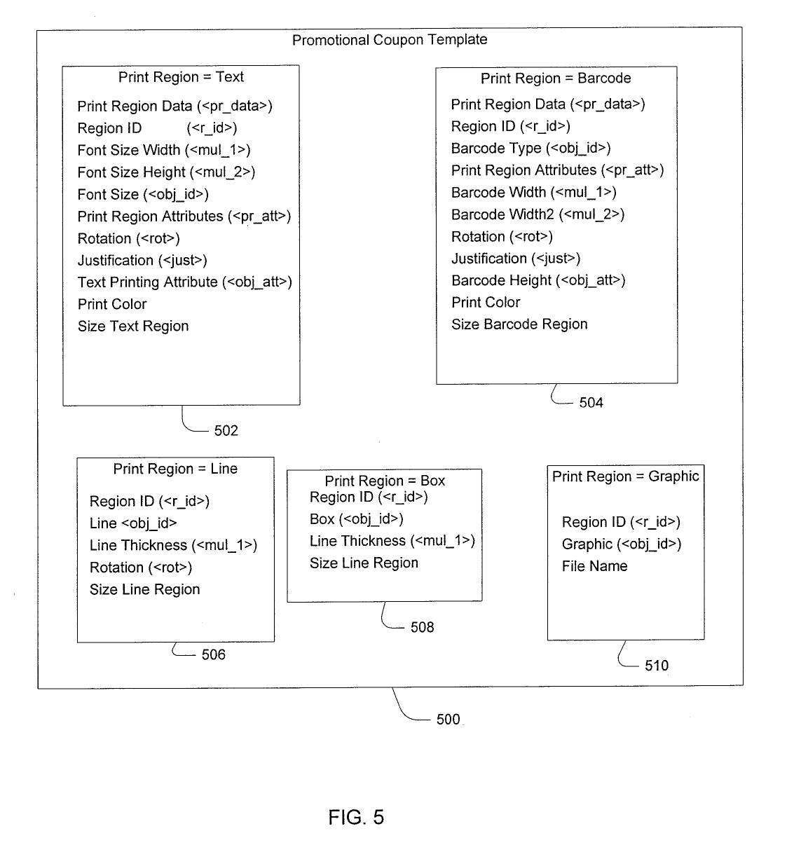

As illustrated the process begins (300) with the design (302) of a promotional coupon template 303 which is used to create promotional coupons. Print regions can be added, edited, or deleted (304) from a promotional coupon template. The print regions which may be included on a promotional coupon template are those described in FIG. 5. Each promotional coupon template is given (306) a name and a unique identifier. Data for each promotional coupon template may be used in a promotion or a plurality of promotions. The data for a promotional coupon template may be transmitted to and stored on a host system 307. All or some of the data for each promotional coupon template also may be transmitted to, stored in, and used by a printer or plurality of printers 311 to generate a promotional coupon or a plurality of promotional coupons 313.

If a promotional coupon template or plurality of promotional coupon templates is used in a promotion or plurality of promotions, the process continues with the design (308) of a promotion or plurality of promotions 309. Each promotion is given (310) a name and a unique identifier. The promotion duration is set (312), triggers are identified (314), and promotional coupon templates are associated (316). The promotion duration parameters 318 include start and end date, start and end time, and number of issued coupons, among others. The triggers may include those described in FIG. 6. The promotional coupon trigger is given a name and described. The data for each promotion may be transmitted to and stored on a host system. Data for each promotion also may be used in any promotional campaign or plurality of promotional campaigns 320. All or some of the data for each promotion also may be transmitted to, stored in, and used by a printer or plurality of printers to generate a promotional coupon or a plurality of promotional coupons.

In one embodiment of the present invention, when a gaming or other business establishment desires to use a promotional coupon in a promotion, the promotional couponing system defines promotions and promotional campaigns as displays. A gaming or other business establishment defines one or a plurality of triggers by which a promotional coupon or promotional coupons may be generated by a printer and issued to a user or player. The event-based triggers involve factors or parameters known to the printer directly or supplied by the host system. The triggers can operate independently or in logical combination. These triggers are used to associate a promotional coupon or a plurality of promotional coupons with a promotion or plurality of promotions. In addition, these triggers may be used when a promotion is associated with a promotional campaign or a plurality of promotional campaigns. These triggers include amount wagered, amount lost, rate of play, length of play, issuance per trigger, birthday, frequency selector, and issue period, among others.

Other parameters used to define a promotion include promotion start and end dates, a promotion ending period based on number of issued coupons, promotion start and end times, issuing a name for the promotion, assigning one or a plurality of triggers to the promotion, and selecting one or a plurality of promotional coupons for use with the promotion.

The data for a promotion is transmitted to and stored on the host system and may be used in one or a plurality of promotional campaigns. Promotion data may include a unique identifier for each promotion. The data also may include the unique identifier of each associated promotional coupon to interlock data in each promotion with data in each associated promotional coupon.

If a promotion or plurality of promotions is to be used in a promotional campaign or plurality of promotional campaigns, the process continues with the design (322) of a promotional campaign or plurality of promotional campaigns. Each promotional campaign is given (324) a name and a unique identifier. A promotion or plurality of promotions is associated (326) with each promotional campaign. The data for each promotional campaign may be transmitted to and stored on a host system. All or some of the data may be transmitted to, stored in, and used by a printer or a plurality of printers to generate a promotional coupon or a plurality of promotional coupons.

In one embodiment of the present invention, a user may export promotional coupon templates and data for promotional coupons, promotions, and promotional campaigns for incorporation and use by external software applications such as a casino management system or player tracking system.

In another embodiment of the present invention, when a gaming or other business establishment desires to define a promotional campaign, the promotional couponing system defines promotions and promotional campaigns as displays. A gaming or other business establishment defines a promotional campaign by associating one or a plurality of predefined promotions to the promotional campaign, assigning a name to the promotional campaign, and selecting a promotional coupon and triggers.

In another embodiment of the present invention, data for a promotional campaign which may be transmitted to a printer from a host system or routing device, stored in, and used by a printer to generate a promotional coupon or a plurality of promotional coupons, may be combined with data for a promotional coupon or plurality of promotional coupons. In this embodiment of the present invention, when a gaming or other business establishment desires to create or edit a promotional campaign, the promotional couponing system creates graphical displays for the promotions and promotional campaigns. After a gaming or other business establishment creates or edits a promotional campaign, the present invention inserts a tag or field in the promotional campaign data file which identifies the promotional campaign. The present invention also calculates the CRC based on the contents of the promotional campaign data and sends the CRC to a printer or plurality of printers.

In another embodiment of the present invention, data for promotional coupon templates, promotions, and promotional campaigns is stored in the memory of a printer. In this embodiment of the present invention, the promotional couponing system transmits the data for promotional coupon templates, promotions, and promotional campaigns to a printer or plurality of such. When all parameters or triggers of a promotion or a promotional campaign are met, the printer uses the data stored in memory to generate a promotional coupon or a plurality of promotional coupons.

FIG. 4 is a process flow diagram of the promotional couponing system including routing devices in accordance with an exemplary embodiment of the present invention.

The process is as described in FIG. 3 with the inclusion of one or more routing devices 400, wherein all or some of the data for each promotional coupon template, promotion, and/or promotional campaign also may be transmitted to and stored in a routing device or a plurality of routing devices, each coupled to a host system and a printer or a plurality of printers. The routing device may then transmit the stored data to a printer to generate a promotional coupon or a plurality of promotional coupons.

In another embodiment of the present invention, data for promotional coupon templates, promotions, and promotional campaigns is stored in a routing device or a plurality of routing devices, each coupled to a host system and a printer or a plurality of printers. In this embodiment of the present invention, the promotional couponing system transmits the data for promotional coupon templates, promotions, and promotional campaigns to each routing device. When all the parameters or triggers for a promotion or promotional campaign are met, the routing device transmits the stored data to the printer or a plurality of printers to generate a promotional coupon or a plurality of promotional coupons.

FIG. 5 is an illustration of the attributes of the print regions of a promotional coupon template in accordance with an exemplary embodiment of the present invention.

As illustrated, a promotional coupon template 500 may include print regions of text 502, barcodes 504, lines 506, boxes 508, and graphics 510. All or some of the data produced by each print region may be stored partially resident in the printer and partially supplied by the host system or routing device.

In one embodiment of the present invention, when a gaming or other business establishment desires to define a promotional coupon, the business establishment uses a promotional coupon template editor to layout and print regions of text, graphics, barcodes, lines, and boxes using defined displays. A gaming or other business establishment defines the layout of a promotional coupon by placing print regions on the promotional coupon template. For example, if the user desires to place a barcode as a print region on the promotional coupon template, the user selects the barcode option to define the parameters for that barcode. The parameters include region ID, region data, region size, object ID, object rotation, object width, object justification, object attributes, print attributes, and print color among others. These parameters are also used to modify a print region.

In another embodiment of the present invention, the user can move any region to another area on a promotional coupon template, place a region in front of other regions, or place a region behind other regions.

In another embodiment of the present invention, a user may create multiple promotional coupon templates based on existing promotional coupon templates. In this embodiment, a gaming or other business establishment selects an existing promotional coupon template on which additional promotional coupon templates are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions on a promotional coupon template.

In another embodiment of the present invention, a user is allowed to adjust the workspace for structuring the promotional coupon template. Thus, if desired, the user can zoom in on the overall layout and print regions of a promotional coupon template to closely view and modify the overall layout and print regions. This feature also permits users to zoom out to view the overall layout and print regions of a promotional coupon template.

In another embodiment of the present invention, after the gaming or other business establishment defines the print regions for the promotional coupon template, the data for the promotional coupon template is stored in a document. The document contains multiple lines. A line in the document may consist of a unique identifies for the promotional coupon template, a comment, or a command and the associated parameters required to use that promotional coupon template, among others. The document is transmitted to, stored on a host system and may be incorporated into a new or existing promotion. The data may also be transmitted to, stored in, and used by a printer either alone or with other promotional coupon templates to generate a promotional coupon or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

The attributes for a text print region are defined in Table I as follows:

TABLE I

| Attribute | Description |
|---|---|
| Print Region Data (<pr_data>) | Permanently stored data. Can modify if <pr_att> = |
| | dynamic, incrementing, or decrementing |
| Region ID (<r_id>) | Print Region identifier. Unique alphanumeric character |
| Font Size Width (<mul_1>) | The width of the size of the font. |
| Font Size Height (<mul_2>) | The height of the size of the font. |
| Font Size (<obj_id>) | An object identifier which describes the size of the font. |
| Print Region Attributes (<pr_att>) | Special handling instructions for the print region. Options |
| | for text include: Dynamic, Stored, Incrementing, or |
| | Decrementing. |
| Rotation (<rot>) | Rotation of strings or data with the print region. Options |
| | include: 0, 90, 180, or 270 Degrees. |
| Justification (<just>) | Justification of data within the print region. Options |
| | include: Left, Right, or Center. |
| Text Printing Attribute (<obj_att>) | Special handling instructions for the print object. Options |
| | for text include: Normal or Inverse. |
| Print Color | Color of the print region. |
| Size Text Region | Sizing for the print region. Shrink/Enlarge Width and Height. |

The attributes for a barcode print region are defined in Table II as follows:

TABLE II

| Attribute | Description |
|---|---|
| Print Region Data (<pr_data>) | Permanently stored data. Can modify if <pr_att> = |
| | dynamic, increment, or decrement |
| Region ID (<r_id>) | Print Region identifier. Unique alphanumeric character. |
| Barcode Type (<obj_id>) | An object identifier which describes the type of barcode |
| | used. |
| Print Region Attributes (<pr_att>) | Special handling instructions for the print region. |
| | Options for barcodes include: Dynamic, Stored, |
| | Increment, or Decrement. |
| Barcode Width (<mul_1>) | The first width of the barcode. |
| Barcode Width2 (<mul_2>) | The second width of the barcode. |
| Rotation (<rot>) | Rotation of strings or data with print region. Options |
| | include: 0, 90, 180, or 270 Degrees. |
| Justification (<just>) | Justification of data within print region. Options include: |
| | Left, Right, or Center. |
| Barcode Height (<obj_att>) | The height of the barcode. |
| Print Color | Color of the print region. |
| Size Barcode Region | Sizing for the print region. Shrink/Enlarge Width and Height. |

The attributes for a line print region are defined in Table III as follows:

TABLE III

| Attribute | Description |
|---|---|
| Region ID (<r_id>) | Print Region identifier. Unique |
| | Alphanumeric Character. |
| Line (<obj_id>) | An object identifier which describes a line. |
| Line Thickness (<mul_1>) | The thickness of the line. |
| Rotation (<rot>) | Rotation of strings or data with print region. |
| | Options include: 0,90, 180, or 270 Degrees. |
| Size Line Region | Sizing for the print region. Shrink/Enlarge |
| | Width and Height |

The attributes for a box print region are defined in Table IV as follows:

TABLE IV

| Attribute | Description |
|---|---|
| Region ID (<r_id>) | Print Region identifier. Unique |
| | Alphanumeric Character. |
| Box (<obj_id>) | An object identifier which describes a box. |
| Line Thickness (<mul_1>) | The thickness of the line. |
| Size Box Region | Sizing for the print region. Shrink/Enlarge |
| | Width and Height |

The attributes for a graphic print region are defined in Table V as follows:

TABLE V

| Attribute | Description |
|---|---|
| Region ID (<r_id>) | Print Region identifier. Unique |
| | Alphanumeric Character. |
| Graphic (<obj_id>) | An object identifier which describes a graphic. |
| File Name | Name of the graphic file. |

FIG. 6 is an illustration of triggers in accordance with an exemplary embodiment of the present invention.

As previously described, triggers are event-based and involve factors or parameters known to the printer directly or supplied by the host system. These triggers can operate independently or in logical combination. These triggers are used to associate a promotional coupon or a plurality of promotional coupons with a promotion or plurality of promotions.

In addition, triggers may be used when a promotion is associated with a promotional campaign or a plurality of promotional campaigns.

Possible triggers 600 for the issuance of a promotional coupon or plurality of such may include any or all of the following, among others:

Time of day trigger uses a time of the day.

Date trigger uses a date.

Number of plays trigger uses a number of plays of a gaming machine.

Player ID trigger uses an identification of a player. This data may be from a player tracking system.

Player classification trigger uses a classification associated with a player. This data may be from a player tracking system.

Cash-out amount trigger uses an amount issued at the time of cash-out of a gaming machine.

Promotion enabled trigger uses the promotion when the promotion is enabled.

Amount wagered trigger uses an amount played.

Amount lost trigger uses an amount lost.

Max Bet Percentage trigger uses a percentage based on the number of times the maximum bet button on a gaming machine is pressed.

Time Played After Reward trigger uses an amount of time that a player played after a reward was issued.

Time played trigger uses an amount of time that is played.

Birthday trigger uses a date of birth.

Frequency selector trigger uses a number of occurrences at any given time.

Issue period trigger uses a period when a promotional coupon or plurality of such is issued.

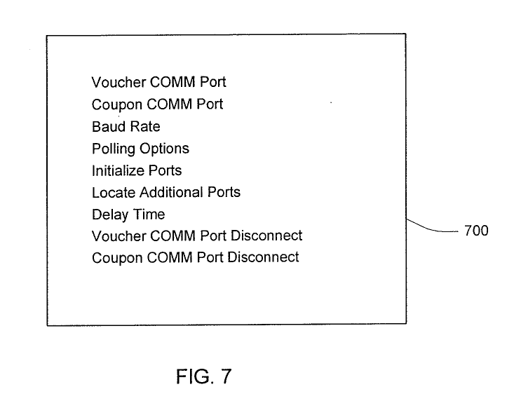

FIG. 7 is an illustration of the attributes of the communication settings with a printer in accordance with an exemplary embodiment of the present invention.

The communication settings 700 in a promotional couponing system are used to set the communication options for both vouchers and promotional coupons to print using the same printer.

The following describes each attribute. Voucher COMM Port is used to identify the communication port used for voucher printing. Coupon COMM Port is used to identify the communication port used for promotional coupon printing. Baud Rate is used to set the data transmission rate for the Voucher COMM port and the Coupon COMM port. Polling Options are used on the Voucher COMM Port and the Coupon COMM port to poll the printer status. During polling, the status of the printer is sent to the promotional couponing system.

Initialize Ports is used to set up each port for data transmission. Locate Additional Ports is used to find other ports which may be available on a printer. Delay Time is used to set the time to delay printing of a voucher and a promotional coupon. Voucher COMM Port Disconnect is used to disconnect communication with the Voucher COMM Port. Coupon COMM Port Disconnect is used to disconnect communication with the Coupon COMM Port.

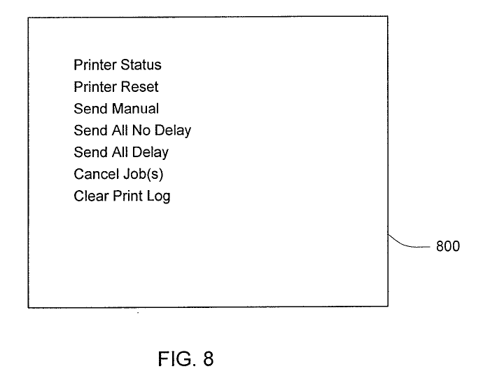

FIG. 8 is an illustration of the attributes of the printer settings 800 in accordance with an exemplary embodiment of the present invention.

The following describes each attribute. Printer Status is used to determine the status of the printer. Printer Reset is used to reset the printer should an error occur. Send Manual is used to manually send each print job to the printer. Send All No Delay is used to send all print jobs to the printer without delaying any of the print jobs. Send All Delay is used to send all print jobs to the printer using the Delay Time attribute of FIG. 7. Cancel Job(s) is used to cancel all print jobs currently queued to the printer. Clear Print Log is used to clear the file which logs each print job.

In one embodiment of the present invention, various methods of establishing communications with a printer for data transmission are provided. For example, when a gaming or other business establishment desires to set up the communication port to which data is transmitted to a printer, the communication port settings displays. A gaming or other business establishment selects the communication port and the communication protocol baud rate, identifies the polling option and command, and initializes the communication port. In addition, a gaming or other business establishment can locate additional communication ports to which to establish communications.

In another embodiment of the present invention, when a gaming or other business establishment desires to set up the respective communication ports to which gaming or vending vouchers and promotional coupon data is transmitted to a printer, the communication ports settings displays. A gaming or other business establishment selects a gaming or vending voucher file, selects the communication port and the communication protocol baud rate, and initializes the communication port for the gaming or vending voucher. A gaming or other business establishment repeats this process for a promotional coupon.

In another embodiment of the present invention, a gaming or other business establishment can also set the delay between print option which sets the delay print time between printing a gaming or vending voucher and printing a promotional coupon. A gaming or other business establishment can also disconnect the communication port for the gaming or vending voucher, the promotional coupon, or both.

In another embodiment of the present invention, when a gaming or other business establishment desires to view the parameters of a print job prior to sending a data to a printer, the print job controls a display. A gaming or other business establishment can select options such as manually sending the print job, sending all print jobs without delay, sending all print jobs with delay, canceling a print job, and clearing the output log that is created when a print job is sent to a printer.

In another embodiment of the present invention, a gaming or other business establishment can also view the status of a printer. When desiring to do so, the printer status is displayed. A gaming or other business establishment can view any Universal Asynchronous Receiver Transmitter (UART) errors, view the printer library, and reset the printer if necessary.

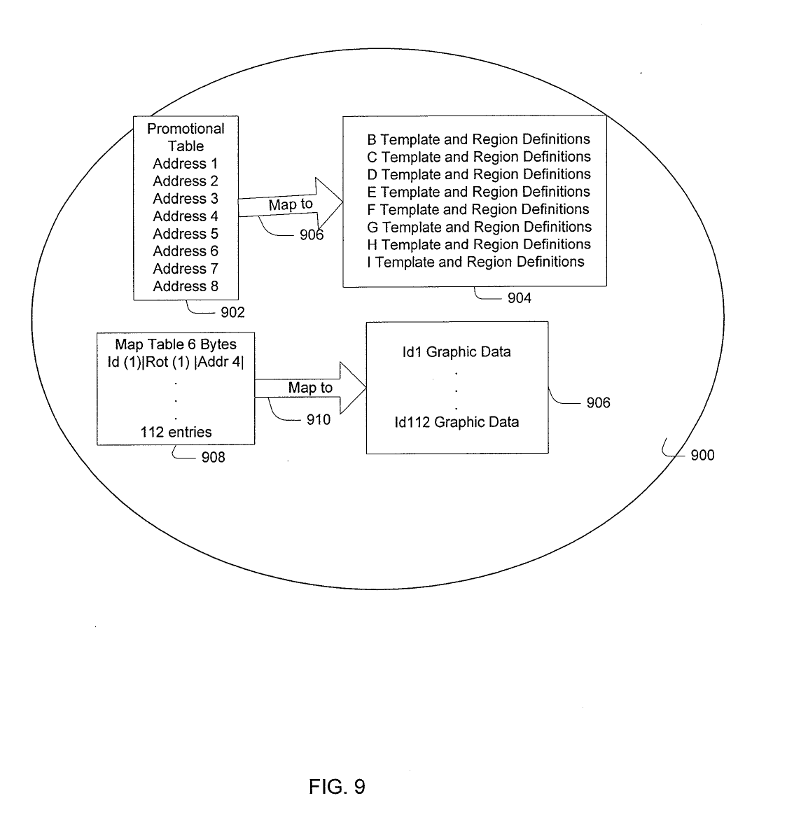

FIG. 9 is an illustration of data 900 transmitted to and stored in the memory of a printer for promotional coupons, promotions, and promotional campaigns in accordance with an exemplary embodiment of the present invention.

As illustrated, the printer memory comprises a promotional table 902, template and region definitions 904, and graphics. The promotional table comprises one or a plurality of addresses. Each address is mapped (906) to a template and region definitions. For example, Address 1 may be mapped to B Template and Region Definitions, Address 2 may be mapped to C Template and Region Definitions, and so on.

Also illustrated is a map table 908 for graphics transmitted to and stored in the memory of the printer for use with promotional coupons. The map table comprises 6 bytes of graphic data as follows: 1 byte for the object identification (ID), 1 byte for the object rotation (Rot); and 4 bytes for the object address (Addr). In this example, the map table may contain a total of 112 entries. Each entry in the table is mapped (910) to graphic data in memory.

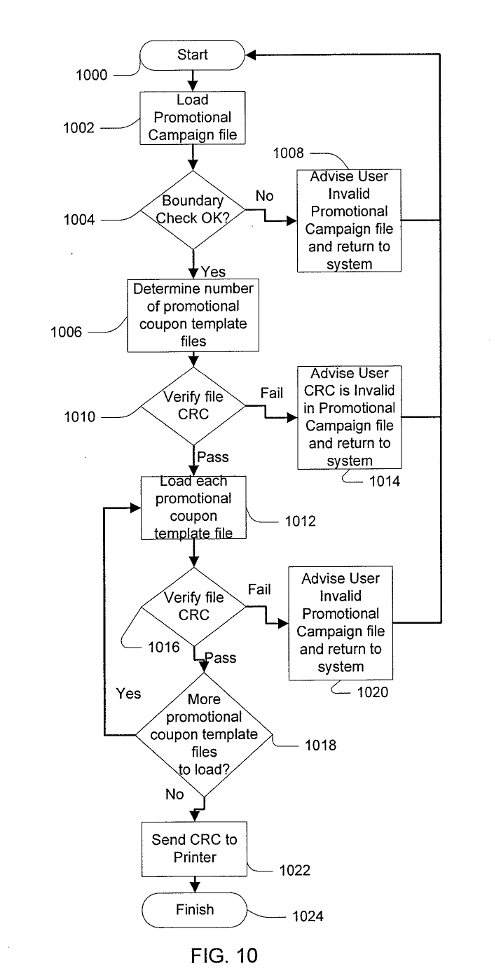

FIG. 10 is a flow chart of the load, check, and verify CRC process for a promotional campaign in accordance with an exemplary embodiment of the present invention.

As illustrated, the process begins (1000) with loading (1002) promotional campaign data. A boundary check is performed (1004). If the promotional campaign data passes the boundary check, the process continues with determining (1006) the number of promotional coupon template files. If the promotional campaign data does not pass the boundary check, the promotional couponing system advises (1008) the user and returns to the promotional couponing system.

After determining the number of promotional coupon template files, a verify file CRC (1010) is performed on the promotional campaign data. If the promotional campaign data passes the CRC verification, the process continues with the loading (1012) of each promotional coupon template. If the promotional campaign data does not pass the CRC verification, the system advises (1014) the user and returns to the promotional couponing system.

After loading each promotional coupon template, a verify file CRC is performed (1016) on each promotional coupon template in the promotional campaign data. If the promotional campaign data passes the CRC verification, the process continues with the loading (1018) of additional promotional coupon templates. If the promotional campaign data does not pass the CRC verification, the system advises (1020) the user and returns to the promotional couponing system.

After loading all promotional coupon templates is finished, the process completes with the CRC being sent (1022) to the printer and finishes (1024).

In one embodiment of the present invention, a CRC is calculated based on the contents of the promotional coupon data. In this embodiment of the present invention, when a gaming or other business establishment desires to create or edit a promotional coupon template, the promotional coupon template editor displays. After a gaming or other business establishment creates or edits a promotional coupon template, the present invention inserts a tag or field into the promotional coupon template data file which identifies the promotional coupon template. The present invention then performs a boundary check on the data file and calculates the CRC based on the contents of the promotional coupon data file. After successful verification of the CRC, the present invention loads the data for each promotional coupon and sends the CRC to a printer or plurality of printers.

In one embodiment of the present invention, a CRC is calculated based on the contents of the promotion data. In this embodiment of the present invention, when a gaming or other business establishment desires to create or edit a promotion, the promotions and promotional campaigns are defined as displays. After a gaming or other business establishment creates or edits a promotion, the present invention inserts a tag or field into the promotion data file which identifies the promotion. The present invention then performs a boundary check on the data file and calculates the CRC based on the contents of the promotion file. After successful verification of the CRC, the present invention loads the data for each promotion and sends the CRC to a printer or plurality of printers.

In another embodiment of the present invention, a boundary check on the combined promotional coupon template or plurality of promotional coupon templates, print regions, graphics and other data which may be included with the promotion or promotional campaign data may be performed to ensure conformance with the resources and load requirements of the printer. In this embodiment of the present invention, after a gaming or other business establishment transmits data to a printer, the promotional couponing system performs the boundary check by determining the number of promotional coupon templates, print regions, graphics and other data which may be included with promotion or promotional campaign data. The promotional couponing system then verifies the CRC. After successful verification of the CRC, the promotional couponing system loads the data for each promotional coupon template and sends the CRC to a printer or plurality of printers.

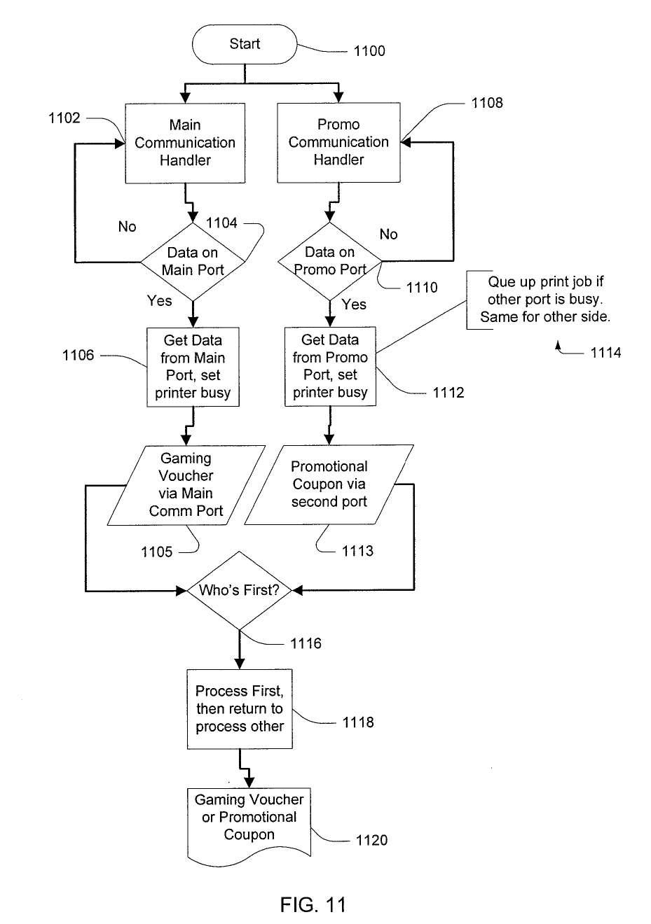

FIG. 11 is a process flow diagram for gaming vouchers and promotional data in a gaming environment in accordance with an exemplary embodiment of the present invention.

As illustrated, the process for gaming vouchers begins (1100) with a main communication handler 1102. If data, such as a gaming voucher, exists (1104) on the main port, the system gets the data 1105 from the main port and sets the printer to busy (1106). If data does not exist on the main port, the process returns to the main communication handler.

The process for promotional coupons begins with a promo communication handler 1108. If data such as a promotional coupon exists (1110) on the promo port, the system gets (1112) the data (1113) from the promo port and sets the printer to busy. If data does not exist on the promo port, the process returns to the promo communication handler.

If the printer is busy using any port, the data from the other port is queued (1114).

The process continues with the promotional couponing system identifying (1116) which data was received first. After identifying the data received first, the promotional couponing system processes (1118) the first data to generate a gaming voucher or promotional coupon, then returns to process the second data to generate a gaming voucher or promotional coupon.

FIG. 12 is an illustration of the servers, cluster controllers, slot machines, and components thereof used for a promotional couponing system in a gaming environment in accordance with an exemplary embodiment of the present invention. A component or plurality of components shown in FIG. 12 could be optional.

As illustrated, a host system 1200 includes a promotional couponing server 1202, a player tracking server 1204, a slot accounting server 1206, a POS server 1208, a gateway server 1210, and other add on modules 1212, each coupled to each other.

The promotional couponing server is used to process data related to promotional couponing such as that described in FIG. 3, FIG. 4, FIG. 5, FIG. 6, FIG. 10, and FIG. 11. For example, to create a promotional coupon using a birthday as a trigger and an issuing location, the promotional couponing server may query data such as a player's date of birth from the player tracking server and machine information from the slot accounting server. To continue with this example, before the promotional coupon can be redeemed at a point-of-sale location, the POS server may query the player tracking system for a player's date of birth. The POS server also may query the slot accounting server to validate machine information such as issuing location. The POS server also may query the promotional couponing server to validate data for the promotional coupon such as the unique identifier for the promotional coupon.

The player tracking server is used to process data related to player tracking. For example, the promotional couponing server may query data such as a player's name from the player tracking server to customize a promotional coupon with the name of an individual.

The slot accounting server is used to process data related to slot machines. For example, the promotional couponing server may query data such as the machine identification from the slot accounting server to unique identify the originating machine which issued a promotional coupon.

The POS server is used to process data related to promotional coupon redemption and point-of-sale purchases. For example, in order to validate a promotional coupon for redemption, the POS server may query data such as the unique identifier for the promotional coupon from the promotional couponing server.

Other add-on modules is used to process data and support other systems such as a lodging management system, among others. For example, to redeem a promotional coupon for a discount on lodging, a lodging management system may query the promotional couponing system to validate the promotional coupon.

The gateway server is coupled to one or more cluster controllers, such as cluster controllers 1214a and 1214b. Each cluster controller further coupled one or more slot machines. For example, cluster controller 1214b is coupled to slot machines 1216a to 1216e and cluster controller 1214a is coupled to slot machines 1218a to 1218d. Each cluster controller is used to control the operation of the associated slot machines. For example, one cluster controller may be used for slot machines located at the north end of a casino floor while another cluster controller may be used for slot machines located at the south end of the casino floor.

Each slot machine may comprise a Slot Machine Interface Board (SMIB) 1220, the SMIB coupled to various components which may include a display 1222, bonusing 1224, bill acceptor 1226, Player Tracking (PT) card reader 1228, game interface 1230, and a Printer Controller Unit (PCU 1232) for controlling a printer 1234.

The game interface also may be coupled to a printer controller unit, the printer controller unit further coupled to a printer.

The gateway server is used to process data and convert protocols from all other servers to a cluster controller or a plurality of such. For example, data for the issuance of a promotional coupon or plurality of such is sent from a promotional couponing server and any of the other servers in a host system through a gateway server to each cluster controller. The data is then forwarded to the associated slot machines or to selected slot machines. The data resides in the printer controller unit until a trigger or a plurality of triggers as described in FIG. 6 are met. Thereafter, the data is used by the printer to generate a promotional coupon or plurality of such.

FIG. 13 is a process flow diagram for a promotional couponing system in a gaming environment for the management, issuance, and redemption of promotional coupons as related to point-of-sale purchases in accordance with an exemplary embodiment of the present invention. A component or plurality of components shown in FIG. 13 could be optional.

FIG. 13 includes all the components described in FIG. 12. An additional component is a handheld device 1300. The handheld device may be used to download data for a promotional coupon template, a promotion, a promotional campaign, a plurality of any, or a combination of any to a printer controller unit for the issuance of a promotional coupon or plurality of such.

As illustrated, a promotional coupon 1302 is issued from a printer in a slot machine. When the promotional coupon is redeemed at a point-of-sale location 1304, the POS server gathers data from the promotional coupon and queries the other servers in a host system to validate any or all of that data. Upon successful validation, the promotional coupon is redeemed.

Also illustrated is a correlation between promotional coupons and player loyalty cards 1304. For example data sent from the host system may include a trigger based on player tracking information such as player identification. When the player tracking card reader of a slot machine reads a player loyalty card and identifies the player, the trigger is set and a promotional coupon may be generated by the printer. In addition, the player loyalty card may be used to verify or validate a promotional coupon when that promotional coupon is redeemed.

In one embodiment of the present invention, the promotional couponing system monitors and tracks the redemption of promotional coupons. When a promotional coupon is redeemed at a point-of-sale location such as a store or restaurant, data gathered from the promotional coupon is transmitted to the promotional couponing system. For example, this data may come from barcode data, the unique identifier for each promotional coupon, or a combination thereof, among others.

In another embodiment of the present invention, to allow redemption of the promotional coupon, the data may be verified against data originally used to create a promotional coupon template, promotion, promotional campaign, a plurality of any, or a combination of any. If the data from the promotional coupon meets any condition or parameter originally set, the promotional coupon is redeemed.

In another embodiment of the present invention, the promotional couponing system is coupled to a point-of-sale server to validate the redemption of promotional coupons. Data gathered from a promotional coupon being redeemed is validated against data originally set for a promotional coupon, a promotion, a promotional campaign, a plurality of any, or a combination of any. If the data from the promotional coupon meets any condition or parameter originally set, the promotional coupon is redeemed.

In another embodiment of the present invention, the promotional couponing system is coupled to a player tracking server in a gaming environment to validate the redemption of promotional coupons. Player tracking data used with promotional coupon, promotion, or promotional campaign data is validated against data originally used for a promotional coupon, a promotion, a promotional campaign, a plurality of any, or a combination of any. If the data is verified, the promotional coupon is redeemed.

In another embodiment of the present invention, the promotional couponing system is coupled to a slot accounting server in a gaming environment to request data for the issuance of a promotional coupon or plurality of such based on a promotional coupon template. For example, using the invention described herein, a gaming establishment creates a promotional campaign which uses a trigger that issues a promotional coupon after a player plays 15 times on the same slot machine. The trigger uses data from the slot accounting server. Once the conditions and parameters of the trigger are met, a promotional coupon is issued. In another example, a trigger for amount wagered may be used to request amount wagered data from the slot accounting server. Once such data is received from the slot accounting server, a promotional coupon is issued.

In another embodiment of the present invention, the promotional couponing system is coupled to a slot accounting server in a gaming environment to verify the issuance of a promotion coupon or plurality of such based on a promotional coupon template. For example, data originally set in a promotional coupon template may include a machine identification. When a promotional coupon is issued, the identification of the issuing machine is transmitted from the slot accounting server and placed on a promotional coupon. When a promotional coupon is redeemed, the promotional couponing system verifies the data from the promotional coupon with the data originally set with a promotional coupon template. If the data matches, the promotional coupon is redeemed.

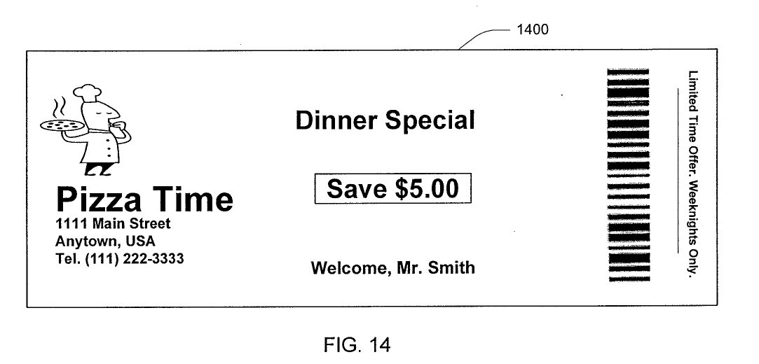

FIG. 14 is an illustration of a promotional coupon including logical fields in accordance with an exemplary embodiment of the present invention. In this example, a promotional coupon 1400 may include five types of print regions: text, barcode, graphic, line, and box as described in FIG. 5. The print regions of a promotional coupon template used to create this example are defined in the promotional couponing system and may be stored in a host system, router, printer, a plurality of any or a combination of any. The template may include a plurality of print regions in combination, resulting in a paste-up style printed coupon.

The data may be stored partially resident in the printer and partially supplied by the host system or routing device whereby the actual value of data for each print region may or may not be included in the promotional coupon template. For example, a promotional coupon template may include a barcode field for printing a barcode. However the actual value of the barcode is transmitted to a printer at the time a promotional coupon is generated using a promotional coupon template. In this way, a promotional coupon may have print regions that include static data, such as a graphic in a graphic print region, or dynamic data such as the name of a particular patron in a text print region. In this way, customized promotional coupons may be printed by a printer without transferring large amounts of data through a communications network.

In addition, data that is used to track the usage of promotional coupons may be included in a promotional coupon. For example, a barcode field or a text field may be used to print a barcode value or text string uniquely identifying the promotional coupon. In this way, a printer creates an image of a barcode or barcodes, characters or marks that may be read by a gaming or vending machine bill acceptor on the same or another gaming or vending machine, allowing automatic acceptance of promotional coupons.

What is claimed is:

1. A method for a promotional couponing system, comprising:
defining a promotional coupon template written in a template definition language;
defining a promotion for the promotional coupon template, the promotion comprising triggers for triggering the printing of promotional coupons using the promotional coupon template;
defining a promotional campaign associating the promotion to an event; and
using the promotional campaign, promotion and promotional coupon template to print a promotional coupon based on the event and the triggers.

2. The method of claim 1, wherein the promotion is selected from the group including a promotion of a tangible product, a promotion for an intangible product, a promotion for a service, a promotion for an event, and a promotion for lodging.

3. The method of claim 1, wherein the event of the promotional campaign is selected from the group including a holiday, a contest, a drawing, a tournament, and a sports event.

4. The method of claim 1, further comprising transmitting the promotional coupon template, promotion, and promotional campaign to a host system for management of the promotional campaign.

5. The method of claim 1, further comprising transmitting the promotional coupon template, promotion, and promotional campaign to a printer for management of the promotional campaign.

6. The method of claim 1, further comprising transmitting the promotional coupon template, promotion, and promotional campaign to a routing device for management of the promotional campaign.

7. The method of claim 1, wherein the promotional coupon template, promotion, and promotional campaign are distributed across a host system and a printer.

8. The method of claim 7, wherein the promotional coupon template, promotion, and promotional campaign are further distributed across a routing device.

9. The method of claim 1, further comprising calculating a CRC based on the contents of the promotional coupon template before transmission of the promotional coupon template to a host system for management of the promotional campaign.

10. The method of claim 9, further comprising verifying by the host system the promotional coupon template using the CRC.

11. The method of claim 1, further comprising calculating a CRC based on the contents of the promotion before transmission of the promotion to a host system for management of the promotional campaign.

12. The method of claim 11, further comprising verifying by the host system the promotion using the CRC.

13. The method of claim 1, further comprising calculating a CRC based on the contents of the promotional campaign before transmission of the promotional campaign to a host system for management of the promotional campaign.

14. The method of claim 13, further comprising verifying by the host system the promotional campaign using the CRC.

15. The method of claim 1, further comprising:
transmitting the promotional coupon template, promotion and promotional campaign to a host system that manages the promotional campaign; and
monitoring the redemption of the promotional coupons by the host system using promotional coupon data transmitted from a point-of-sale location when the promotional coupon is redeemed.

16. The method of claim 15, further comprising verifying the promotional coupon against data originally used to create the promotional coupon template, promotion and promotional campaign when the promotional coupon is redeemed.

17. The method of claim 1, further comprising exporting the promotional coupon templates, promotion and promotional campaign to an external software application.

18. The method of claim 1, further comprising:
setting a first communication port over which promotional coupon data is transmitted to and from a printer used for printing the promotional coupon and a voucher; and
setting a second communication port over which voucher data is transmitted to and from the printer.

19. The method of claim 1, further comprising setting a delay print time between printing a gaming or vending voucher and printing a promotional coupon.

20. A promotional couponing system, comprising:
means for defining a promotional coupon template written in a template definition language;
means for defining a promotion for the promotional coupon template, the promotion comprising triggers for triggering the printing of promotional coupons using the promotional coupon template;
means for defining a promotional campaign associating the promotion to an event; and
means for transmitting the promotional campaign, promotion and promotional coupon template to a host system for printing a promotional coupon based on the event and the triggers.

21. The system of claim 20, wherein the promotion is selected from the group including a promotion of a tangible product, a promotion for an intangible product, a promotion for a service, a promotion for an event, and a promotion for lodging.

22. The system of claim 20, wherein the event of the promotional campaign is selected from the group including a holiday, a contest, a drawing, a tournament, and a sports event.

23. The system of claim 20, further comprising means for transmitting the promotional coupon template, promotion, and promotional campaign to a host system for management of the promotional campaign.

24. The system of claim 20, further comprising means for transmitting the promotional coupon template, promotion, and promotional campaign to a printer for management of the promotional campaign.

25. The system of claim 20, further comprising means for transmitting the promotional coupon template, promotion, and promotional campaign to a routing device for management of the promotional campaign.

26. The system of claim 20, wherein the promotional coupon template, promotion, and promotional campaign are distributed across a host system and a printer.

27. The system of claim 26, wherein the promotional coupon template, promotion, and promotional campaign are further distributed across a routing device.

28. The system of claim 20, further comprising means for calculating a CRC based on the contents of the promotional coupon template before transmission of the promotional coupon template to a host system for management of the promotional campaign.

29. The system of claim 28, further comprising means for verifying by the host system the promotional coupon template using the CRC.

30. The system of claim 20, further comprising means for calculating a CRC based on the contents of the promotion before transmission of the promotion to a host system for management of the promotional campaign.

31. The system of claim 30, further comprising means for verifying by the host system the promotion using the CRC.

32. The system of claim 20, further comprising means for calculating a CRC based on the contents of the promotional campaign before transmission of the promotional campaign to a host system for management of the promotional campaign.

33. The system of claim 32, further comprising means for verifying by the host system the promotional campaign using the CRC.

34. The system of claim 20, further comprising:
means for transmitting the promotional coupon template, promotion and promotional campaign to a host system that manages the promotional campaign; and
means for monitoring the redemption of the promotional coupons by the host system using promotional coupon data transmitted from a point-of-sale location when the promotional coupon is redeemed.

35. The system of claim 15, further comprising means for verifying the promotional coupon against data originally used to create the promotional coupon template, promotion and promotional campaign when the promotional coupon is redeemed.

36. The system of claim 20, further comprising means for exporting the promotional coupon templates, promotion and promotional campaign to an external software application.

37. The system of claim 20, further comprising:
means for setting a first communication port over which promotional coupon data is transmitted to and from a printer used for printing the promotional coupon and a voucher; and
means for setting a second communication port over which voucher data is transmitted to and from the printer.

38. The system of claim 20, further comprising means for setting a delay print time between printing a gaming or vending voucher and printing a promotional coupon.

39. The system of claim 20, further comprising a gateway server in a gaming environment coupled to a cluster controller controlling a plurality of slot machines.

40. The system of claim 20, further comprising means in a gaming environment for validating the redemption of the promotional coupons.

41. The system of claim 20, further comprising means in a gaming environment for requesting data for the issuance of the promotional coupon.

42. The system of claim 20, further comprising means in a gaming environment for verifying the issuance of the promotional coupon.
